(19) United States
(12) Patent Application Publication
(10) Pub. No.: US 2012/0105561 A1
(43) Pub. Date: May 3, 2012

(54) TRANSFER INKJET RECORDING METHOD

(75) Inventors: Hiroshi Taniuchi, Yokohama-shi (JP); Riichi Saito, Fujisawa-shi (JP)

(73) Assignee: CANON KABUSHIKI KAISHA, Tokyo (JP)

(21) Appl. No.: 13/280,081

(22) Filed: Oct. 24, 2011

(30) Foreign Application Priority Data
Oct. 28, 2010 (JP) 2010-242466

(51) Int. Cl. B41J 2/01

(52) U.S. Cl. 347/103

(57) ABSTRACT

A transfer inkjet recording method includes the step of applying an aggregating agent onto an image-forming face of an intermediate transfer member, having a pattern including lyophilic portions and a lyophobic portion, the step of forming an intermediate image by applying an ink onto the image-forming face, and the step of transferring the intermediate image to a recording medium from the image-forming face. The lyophilic portions include at least two types of portions having different areas.

### BACKGROUND OF THE INVENTION

1. Field of the Invention

The present invention relates to a transfer inkjet recording method.

2. Description of the Related Art

A transfer inkjet recording method has been known in which an intermediate image is formed by applying an ink to the image-forming face of an intermediate transfer member to which aggregating agent has been applied, and then the intermediate image is transferred to a recording medium, thereby forming a final image. In order to transfer the intermediate image satisfactorily, it is desirable that the image-forming face of the intermediate transfer member have high releasability (or repel inks). It is however difficult to uniformly apply an aggregating agent to a highly releasable image-forming face. Accordingly, Japanese Patent Laid-Open No. 2008-18719 discloses a method of uniformly forming on the image-forming face a pattern (lyophilic portions) that can be easily wetted with an aggregating agent. According to this method, the aggregating agent can be deposited only on the lyophilic portions, consequently being uniformly applied there.

However, the present inventors have found that this method has some disadvantages when the amount of aggregating agent is increased to enhance the aggregation power. Specifically, the disadvantages are as below.

In order to increase the amount of aggregating agent, the area of each lyophilic portion compatible with the aggregating agent can be increased. By increasing the area of each lyophilic portion, not only the base area of the aggregating agent deposited on the lyophilic portions, but also the height of the aggregating agent, is increased. Consequently, the amount of aggregating agent can be increased relative to the case where only the number of the lyophilic portions is increased to increase the base area.

However, the pitch of the lyophilic portions (center-to-center distance between the lyophilic portions) cannot be reduced to less than the diameter (maximum diameter) of the lyophilic portion. If the pitch of the lyophilic portions is smaller than the diameter of the lyophilic portions, the lyophilic portions overlap with one another. Therefore, as the area of each lyophilic portion is increased, the pitch of the lyophilic portions increases accordingly. This may affect the shape of ink dots. The (α) side of FIG. 4 shows the moment an ink has landed on some of the lyophilic portions of the pattern shown in FIG. 3A to which an aggregating agent has been applied. The (β) side of FIG. 4 shows the movement of the ink dots with time from the state shown in the (α) side. Since the lyophilic portions are easily wetted with the aggregating agent, they are also easily wetted with ink. Consequently, some of the ink dots are spread over due to the effect of the lyophilic portions. In contrast, since the lyophobic portions repel the ink, some of the ink dots contract. Thus, the shape of ink dots is more likely to be affected by the lyophilic portions as the area of each lyophilic portion is larger. In this state, the reproduction resolution is varied as is clear from FIG. 3B, which shows the same sate as in the (β) side of FIG. 4. The reproduction resolution is a value of the ink dot pitch measured with reference to the edges of the dots.

In contrast, if the area of each lyophilic portion is reduced, the variations in ink dot shape and reproduction resolution can be reduced, but the amount of aggregating agent on the lyophilic portions is reduced. Consequently, it becomes difficult to collect the ink sufficiently. Consequently, bleeding (color mixing) occurs in the intermediate image and the final image formed on a recording medium some cases.

### SUMMARY OF THE INVENTION

The present invention provides a transfer inkjet recording method that can prevent the deformation of ink dots, the variation in reproduction resolution, and bleeding in the image.

According to an aspect of the invention, in the transfer inkjet recording method, an aggregating agent capable of aggregating a coloring material contained in an ink is applied onto an image-forming face of an intermediate transfer member. The image-forming face has a pattern including lyophilic portions and a lyophobic portion. The lyophilic portions include at least two types of portions having different areas. Then, an intermediate image is formed by applying the ink onto the image-forming face on which the aggregating agent has been applied. The intermediate image is transferred to a recording medium by pressing the recording medium on the image-forming face on which the intermediate image has been formed.

The transfer inkjet recording method can prevent the deformation of ink dots, the variation in reproduction resolution, and bleeding in the image.

Further features of the present invention will become apparent from the following description of exemplary embodiments with reference to the attached drawings.

### BRIEF DESCRIPTION OF THE DRAWINGS

FIG. 1 is a representation of a transfer inkjet recording apparatus.

FIGS. 2A and 2B are representations of a known pattern of lyophilic portions.

FIGS. 3A and 3B are representations of a known pattern of lyophilic portions.

FIG. 4 is a representation of the movement of ink dots on the known lyophilic portions.

FIGS. 5A and 5B are representations of a pattern including lyophilic portions according to an embodiment of the invention.

FIGS. 6A to 6C are representations of patterns including lyophilic portions according to embodiments of the invention.

FIG. 7 is a representation of a pattern including lyophilic portions according to another embodiment of the invention.

FIG. 8 is a block diagram of a control system configured according to a transfer inkjet recording apparatus of an embodiment of the invention.

### DESCRIPTION OF THE EMBODIMENTS

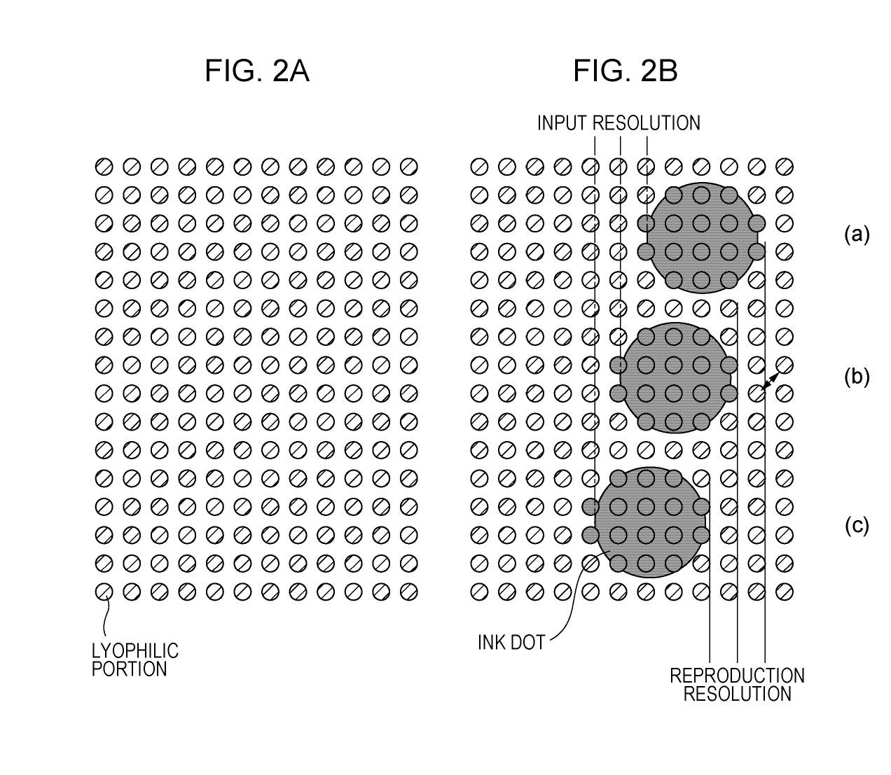

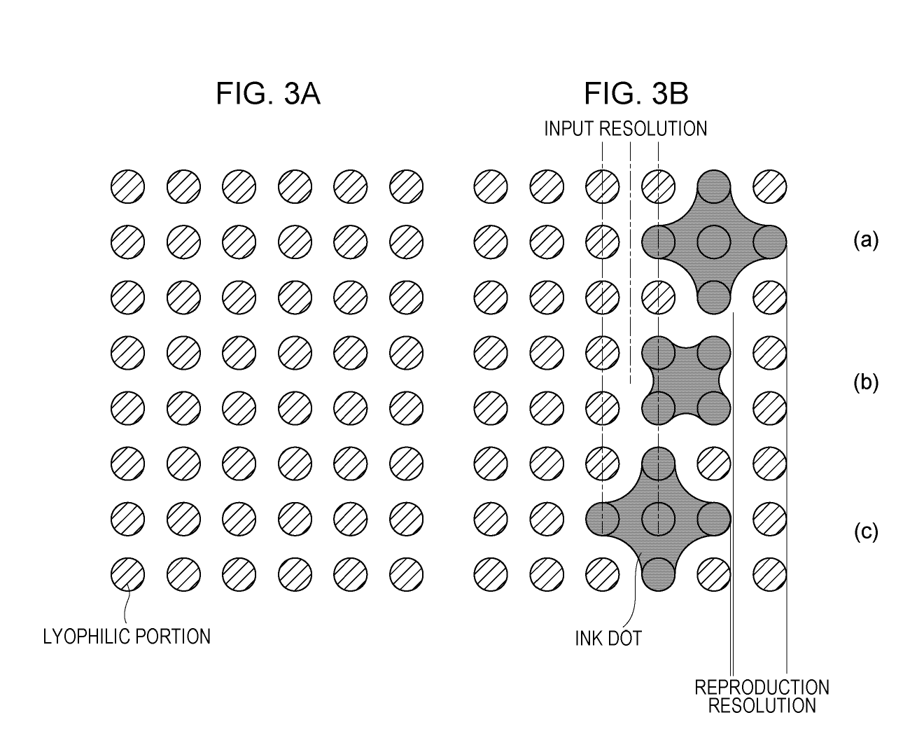

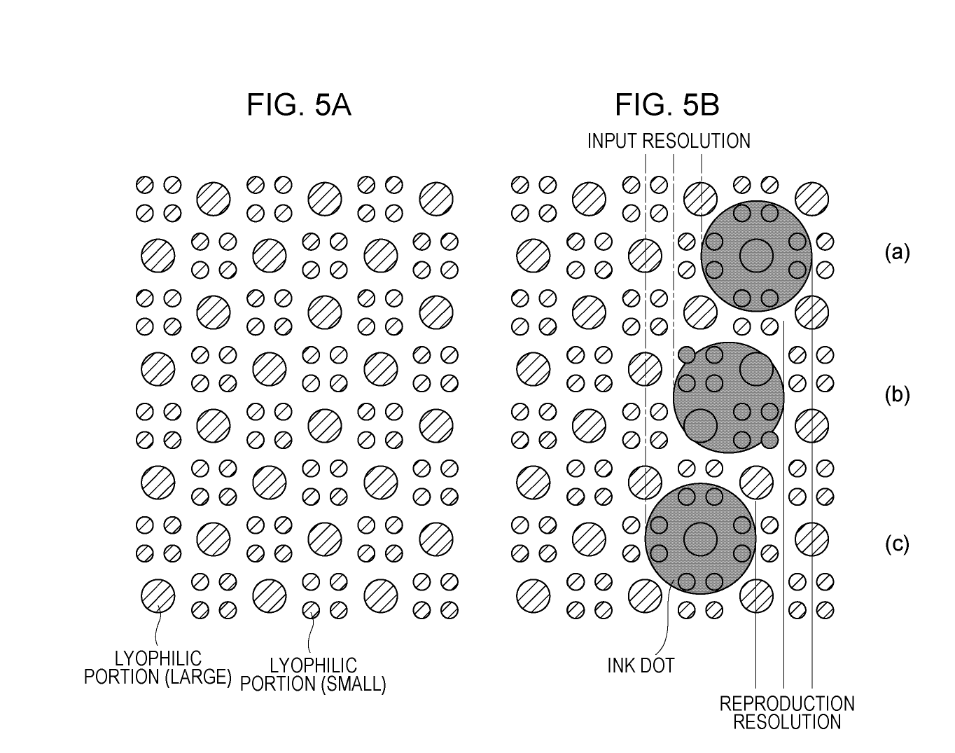

The invention will be further described in detail. FIGS. 5A and 5B are representations of a pattern including lyophilic portions according to an embodiment of the invention. For the sake of comparison, known exemplary patterns of lyophilic portions are shown in FIGS. 2A to 3B. The image-forming face of these intermediate transfer members has a pattern including lyophilic portions and a lyophobic portion. In FIGS. 5A and 5B, the insides of the circles are the lyophilic portions, and the region outside the circles is the lyophobic portion. The “lyophilic portion” mentioned herein refers to a portion that is more easily wetted with an aggregating agent and an ink (on which the aggregating agent and ink are more easily deposited) than the lyophobic portion. The wettability or the repellency of an aggregating agent to the image-forming face can be represented by the contact angle of the aggregating agent with respect to the image-forming face. When the image-forming face can be wetted easily, the contact angle of the aggregating agent is reduced. When the image-forming face repels the aggregating agent, the contact angle is increased. In the present embodiment, the contact angle of the aggregating agent can be 60° or more with respect to the lyophobic portion. In a principle sense, the contact angle of the aggregating agent with the lyophobic portion is not limited by ceiling. The larger the contact angle, the easier the separation. However, if the contact angle of the ink with the lyophobic portion is excessively large, the shapes of the dots may vary irregularly. The contact angle can be controlled in view of the ink or aggregating agent to be used. The appropriate contact angle of the ink with the lyophobic portion is variable, but can be typically 90° or less. In the present embodiment, the lyophilic portion and the lyophobic portion are in a relationship in which an aggregating agent is difficult to deposit on the lyophobic portion, but is easy to deposit on the lyophilic portion. In other words, the lyophilic portion and the lyophobic portion have a difference in wettability to the aggregating agent. The contact angle of the aggregating agent with respect to the lyophilic portion can be 5° or more smaller than that with respect to the lyophobic portion. For example, it is 10° or more smaller. The contact angle of the aggregating agent can be smaller with respect to the lyophilic portion. If the difference in wettability between the lyophilic portion and the lyophobic portion is large, a satisfactory effect can be produced even when the contact angle of the aggregating agent is small with respect to the lyophobic portion.

When an intermediate image is formed on the image-forming face of an intermediate transfer member, in theory, as the uniformity of the pattern formed by the aggregating agent, which is applied before the ink, is increased, the intermediate image is more difficult to deform irregularly. According to this idea, it has been believed that it is desirable that the pattern of lyophilic portions be uniform in such a manner that the regions having the same area and the same shape are regularly arranged at constant intervals, and such a design has been applied to the pattern of the lyophilic portions.

The present inventors however have found that such a uniform pattern has a disadvantage. More specifically, as mentioned above, relationships among the area of each lyophilic portion, the amount of aggregating agent on the lyophilic portions, and the shape and reproduction resolution of ink dots are subject to some constraints. FIGS. 2A and 2B, 3A and 3B and 4 show the simplest model patterns of these relationships. FIGS. 2A and 3A each show a pattern of lyophilic portions of an intermediate transfer member. FIGS. 2B and 3B each show the state where an intermediate image has been formed by applying an aggregating agent to the pattern and further applying an ink to the pattern.

In general, for reproducing a high-definition photographic image by inkjet recording, a high-resolution output of 1200 dpi or more is used. FIGS. 2A and 2B show a pattern whose lyophilic portions are formed at a pitch (center-to-center distance) corresponding to an output resolution of 1200 dpi. When the output resolution is 1200 dpi, the pitch of the lyophilic portions is 21.16 μm. The lyophilic portions shown in FIGS. 2A and 2B each have a circular shape having a diameter of 12 μm. In order to apply an aggregating agent so as not to continue from one lyophilic portion to another in the pattern shown in FIGS. 2A and 2B, the lyophobic portion occupies 8 μm between the lyophilic portions in practice. In the case of FIGS. 2A and 2B, the amount of aggregating agent deposited on the lyophilic portions at a contact angle of 40° is about 0.19 mg per square inch in calculation. The measurement of this amount with an electronic balance was substantially the same. In general, the amount of ink to be applied for recording at a designed resolution of 1200 dpi is at most about 7 mg per square inch for each color. In this instance, the amount of ink coming into contact with the aggregating agent on the intermediate transfer member is 37 times the amount of the aggregating agent on a mass basis. Such an amount of ink can be aggregated in practice. As shown in FIG. 2B, the reproduction resolution of ink dots can be the same as the input resolution. The input resolution is a value determined using the center-to-center distance in target coordinates as an index.

In a practical color image, however, three color inks may overlap with each other, and the amount of ink can exceed 20 mg per square inch in dense color regions. The amount of ink coming into contact with the aggregating agent on the intermediate transfer member increases to 100 times the amount of the aggregating agent on a mass basis. Accordingly, the ink is unlikely to be aggregated sufficiently, and thus bleeding may occur in the intermediate image and the final image.

FIGS. 3A and 3B show a pattern having lyophilic portions whose diameter is increased to 25 μm. The pitch corresponding to a resolution of 1200 dpi is 21.16 μm and smaller than the diameter of the lyophilic portions, that is, 25 μm. If lyophilic portions of 25 μm in diameter are formed at 1200 dpi, the lyophilic portions are connected to each other. Accordingly, the pattern shown in FIGS. 3A and 3B is formed at an output resolution of 600 dpi so that lyophilic portions having a diameter of 25 μm can be formed. In the case of FIGS. 3A and 3B, the amount of aggregating agent deposited on the lyophilic portions at a contact angle of 40° is about 0.6 mg per square inch in calculation. The measurement of this amount with an electronic balance was substantially the same. In this instance, in dense color regions as well, the amount of ink is about 30 times that of the aggregating agent on a mass basis. Accordingly, the ink can be successfully aggregated even in dense color regions by applying onto the lyophilic portions a larger amount of aggregating agent than the amount in the case of FIG. 2B.

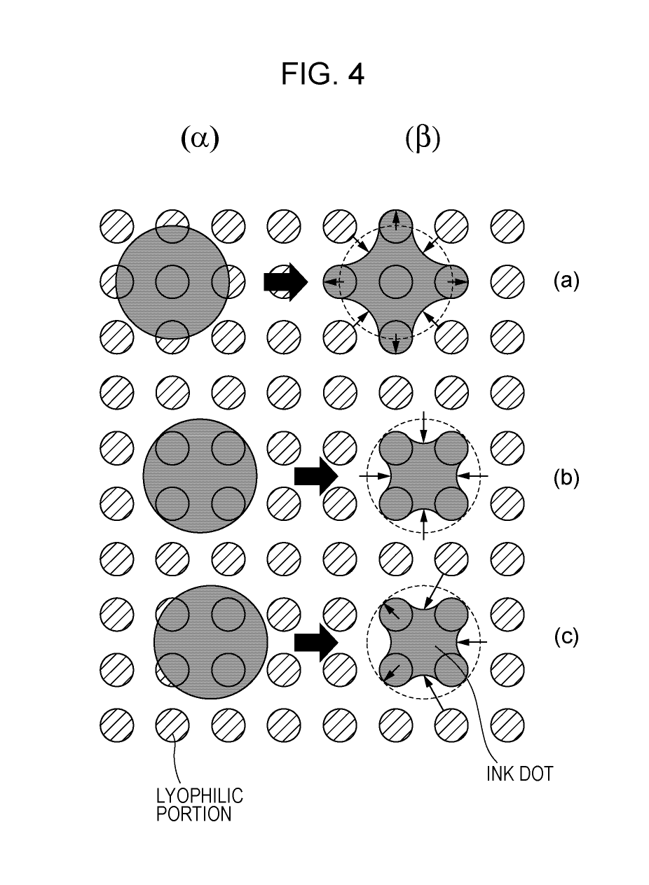

However, when an ink image is formed over the surfaces of such lyophilic portions, the dots of the ink may be deformed so as to be drawn by the lyophilic portions and the aggregating agent, as shown in FIG. 3B or the (β) side of FIG. 4. Also, the reproduction resolution may become irregular. If the ink dots come to a state as shown in FIG. 3B or the (β) side of FIG. 4, the distortion of fine lines or unclear thickened characters are clearly observed, and it becomes difficult to reproduce high-quality images. If the pitch of the lyophilic portions is reduced to increase the resolution, as shown in FIGS. 2A and 2B, bleeding is likely to occur. If the area of the lyophilic portions is increased so that a larger amount of aggregating agent can be deposited, as shown in FIGS. 3A and 3B, the ink dots are likely to be deformed or the reproduction resolution can be varied easily. These disadvantages are peculiar to the transfer inkjet recording method having the particularity of forming images on a releasable intermediate transfer member, and the particularity of inkjet recording methods in which images are formed by staggering and overlapping ink dots larger than the input resolution. FIGS. 2A and 2B, 3A and 3B, and 4 illustrate cases using specific input resolutions and specific amounts of aggregating agent, and, of course, the same problems are present in other cases using different input resolutions and different amounts of aggregating agent.

The present invention has been accomplished on the basis of these disadvantages. In the present embodiment, the lyophilic portions include regions having at least two different areas, as shown in FIG. 5A. In the pattern shown in FIG. 5A, the two different areas are as follows:
Small lyophilic portions: diameter of 12 μm, pitch of 1200 dpi, (arranged in an anomalously staggered manner)
Large lyophilic portions: diameter of 25 μm, pitch of 600 dpi, (arranged in a staggered manner)

In the pattern shown in FIG. 5A, the amount of aggregating agent deposited on the lyophilic portions at a contact angle of 40° is 0.4 mg per square inch, which lies between the cases shown in FIG. 2A and FIG. 3A. In view of the maximum amount of ink to be applied, the amount of ink is about 50 times that of the aggregating agent. Thus, the flexibility in application of the aggregating agent can be twice or more that in the case shown in FIG. 2A. FIG. 5B shows a state where an ink has been applied to the surfaces of such lyophilic portions. As shown in FIG. 5B, the deformation of ink dots can be minimized, and the reproduction resolution can be comparable to that of the case shown in FIG. 2B.

In a pattern including the same lyophilic portions having the same area as in the known pattern, even if the area of the lyophilic portions is optimized, it is difficult to reduce the deformation of the ink dots and the variation in reproduction resolution at a high level while the amount of aggregating agent is maintained. In the present embodiment, the different types of lyophilic portions having different areas function to produce contradictory effects according to their respective areas so that the lyophilic portions having a small area reduce the deformation of ink dots and the variation in reproduction resolution while the lyophilic portions having a large area maintain the amount of aggregating agent.

The patterns of lyophilic portions according to the present embodiment include the following four types:

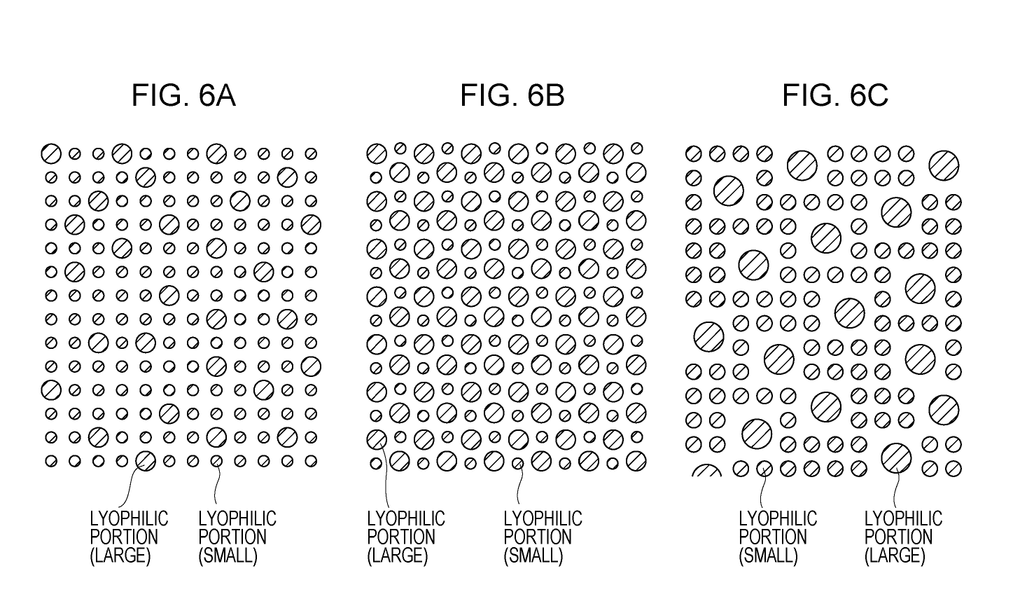

1. Irregular arrangement at a constant pitch, FIG. 6A;
2. Regular arrangement at a constant pitch, FIG. 6B;
3. Irregular arrangement at different pitches, FIG. 6C; and
4. Regular arrangement at different pitches, FIG. 5A.

An appropriate pattern can be selected from these four patterns according to the desired image and quality, and the ink and aggregating agent to be used. For any pattern, the lyophilic portions can be provided so that a droplet of ink can come into contact with both the large lyophilic portion and the small lyophilic portion. The amount of ink that can be aggregated by a unit mass of aggregating agent depends on the composition of the aggregating agent. When a unit mass of aggregating agent can aggregate a large amount of ink, the number of large lyophilic portions with which an ink droplet comes into contact can be minimized, from the viewpoint of reducing the deformation of ink dots and the variation in reproduction resolution.

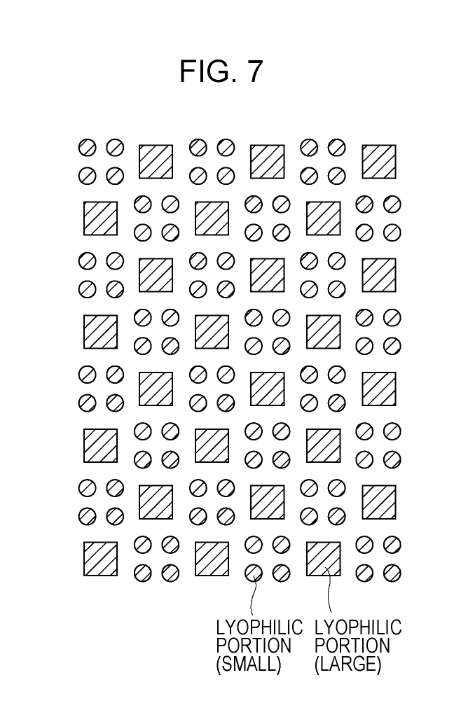

At least one period of the repetitions of the lyophilic portions in the pattern used can be higher than or equal to the designed resolution used for outputting an inkjet image. The largest lyophilic portions of at least two types of lyophilic portions, having the largest area, can have a diameter (maximum diameter) smaller than the maximum diameter of the spread of ink dots ejected from an inkjet head. The diameter (maximum diameter) of the lyophilic portions is the length of the longest straight line between edges of the region of the largest lyophilic portion. The maximum diameter of the spread of ink dots is about 80 μm. Accordingly, the diameter of the largest lyophilic portion can be 80 μm or less. Also, the area of the largest lyophilic portions can be smaller than the area of the ink dots, and is, for example, 5000 μm² or less. In this instance, naturally, the diameter of the smallest lyophilic portions is smaller than the maximum diameter of the spread of the ink dots, and their area is smaller than that of the ink dots. However, if the area of the smallest lyophilic portions is excessively small, the aggregating agent cannot be held on the lyophilic portions. Accordingly, the diameter of the smallest lyophilic portions can be 2 μm or more, and their area can be 4 μm² or more. All the lyophilic portions can be circular, as shown in FIGS. 2A to 6C, but may have other shapes, as shown in FIG. 7. Different shapes may be combined in a pattern. The lyophilic portions includes at least two types of portions having different areas, and the area of the largest lyophilic portions can be at least 1.4 times that of the smallest lyophilic portions. The difference in area between lyophilic portions larger than the smallest lyophilic portions and the smallest lyophilic portions can be 17 μm² or more, and is preferably 77 μm² or more. When the lyophilic portions are circular, the difference in diameter between larger lyophilic portions than the smallest lyophilic portions and the smallest lyophilic portions can be 5 μm or more, and is preferably 10 μm or more. The intermediate transfer member may have steps between the lyophilic portions and the lyophobic portion. The step height is desirably smaller than or equal to the thickness of the aggregating agent applied, and optimally, it is substantially negligible.

The pattern of lyophilic portions can be formed by a known method. For example, a resist method, a mask method, a printing method, or a direct method using a laser can be applied. Among those, the resist method can advantageously perform very fine patterning. Thus, the lyophilic portions are formed so as to have at least two types of portions having different areas by patterning or the like.

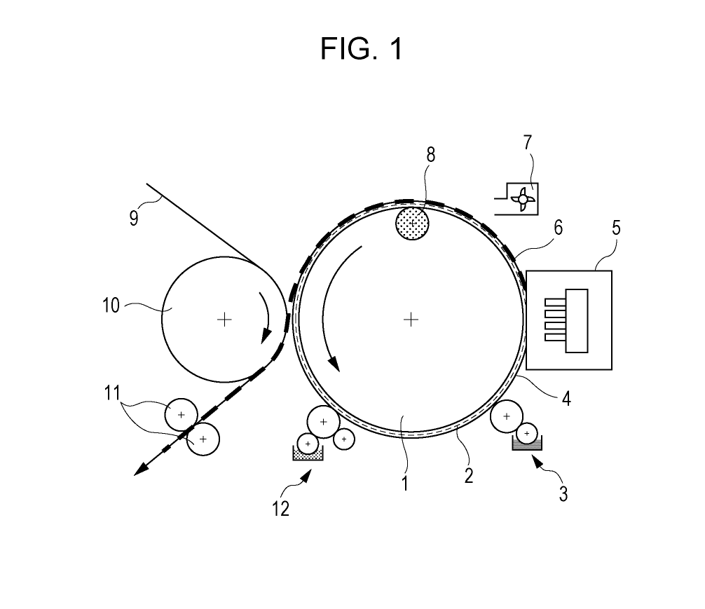

The transfer inkjet recording method according to an embodiment will now be described with reference to FIG. 1. In the transfer inkjet recording method of the present embodiment, an aggregating agent capable of aggregating a coloring material in an ink is applied onto the image-forming face of an intermediate transfer member having a pattern including lyophilic portions and a lyophobic portion. Subsequently, an intermediate image is formed by applying the ink onto the image-forming face to which the aggregating agent has been applied. Then, a recording medium is pressed on the image-forming face on which the intermediate image has been formed. Thus, the intermediate image on the image-forming face is transferred to the recording medium, thereby forming an image.

In FIG. 1, the intermediate transfer member 1 is cylindrical, and the periphery of the cylinder acts as the image-forming face 2 having a pattern including lyophilic portions and a lyophobic portion. The image-forming face 2 opposes an application device 3 that applies the aggregating agent 4, an inkjet recording head 5 that ejects the ink to form an intermediate image 6, and a pressure roller 10 with which the image is transferred to the recording medium 9.

The intermediate transfer member 1 rotates in the direction indicated by the arrow shown in FIG. 1. First, the aggregating agent 4 is applied onto the surface of the intermediate transfer member 1 from the application device 3, and the applied aggregating agent 4 is held on the lyophilic portions on the surface of the intermediate transfer member 1. Thus, a certain amount of aggregating agent can be present uniformly on the intermediate transfer member 1. Subsequently, the ink is ejected from the inkjet recording head 5 to form an intermediate image 6 (mirror-reverse image) on the image-forming face 2 of the intermediate transfer member 1. When the ink and the aggregating agent come into contact with each other, the coloring material in the ink aggregates and, consequently, the fluidity of the coloring material is reduced. Thus, bleeding or the like in the intermediate image can be suppressed. Then, a recording medium 9 is brought into contact with the image-forming face 2 on which the intermediate image 6 has been formed, and is pressed by the pressure roller 10 from the rear side. Thus, the image is transferred to the surface of the recording medium 9 to produce a final image. The recording medium 9 is conveyed by conveying rollers 11.

The apparatus shown in FIG. 1 includes a water removal accelerator 7 like a blower to evaporate and remove the water and solvent in the ink forming the intermediate image 6. The water content in the ink is thus reduced before transfer. Also, a heating roller 8 is provided in contact with the inner wall of the intermediate transfer member 1 for heating. Furthermore, for repeatedly recycling the intermediate transfer member 1 over several times, the image-forming face 2 is washed by a cleaning unit 12 after the intermediate image 6 has been transferred to the recording medium 9.

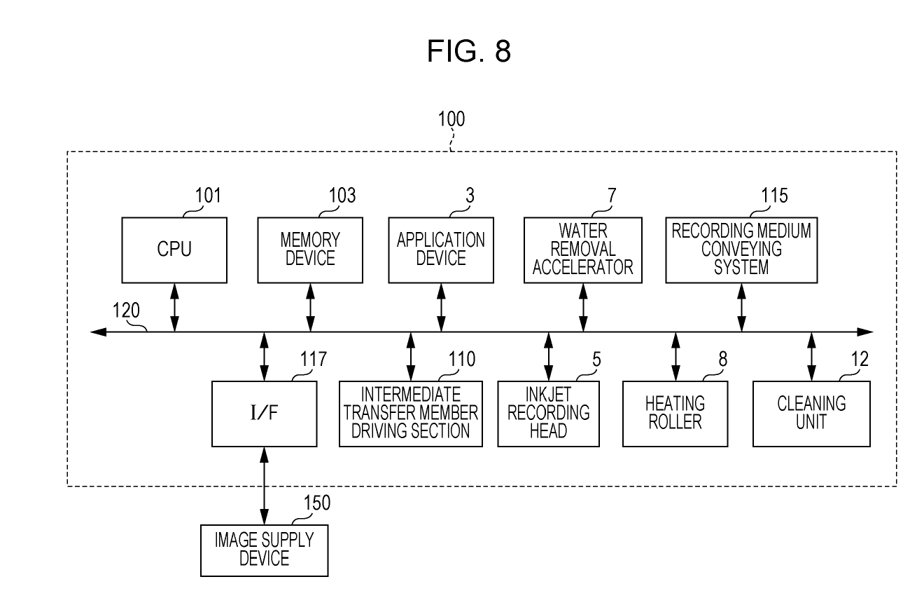

FIG. 8 shows a control system configured according to the transfer inkjet recording apparatus shown in FIG. 1. The control system 100 includes a CPU 101 or main control section that controls the devices and units of the system. A memory device 103 includes a ROM in which the base program of the CPU 101 is stored, and a RAM that will be used for temporarily storing various types of data, processing image data, and other working. An interface 117 allows data and command communications with an image supply device 150, which is an image data source and may be a host computer. A driving section 110 rotates the intermediate transfer member 1. A recording medium conveying system 115 coveys the recording medium 9 and includes the pressure roller 10 and the conveying rollers 11. A bus line 120 connects the above-described devices and, in addition, the application device 3, the inkjet recording head 5, the water removal accelerator 7, the heating roller 8 and the cleaning unit 12, and through which control signals are transmitted from the CPU 101. Each device to be controlled is provided with a condition sensor, and the detection signal of the sensor is transmitted to the CPU 101 through the bus line 120.

Elements and steps in the transfer inkjet recording method of the present embodiment will now be described.

### Intermediate Transfer Member

The intermediate transfer member has a pattern including lyophilic portions and a lyophobic portion, and can be in any form as long as its surface can come into at least line contact with the recording medium. For example, it may be a roller, a belt or a sheet, depending on the form of the recording apparatus or the recording medium to be used. The image-forming face of the intermediate transfer member can be made of an elastic material, such as rubber or plastic. For example, the image-forming face has an elasticity corresponding to a hardness in the range of 10° to 100° when it is measured with a type A durometer (in accordance with JIS K 6253). If the hardness is in the range of 40° to 80°, more types of recording media can be used. Although FIG. 1 shows an intermediate transfer member that continuously transfers images, batch recording may be performed as in pad printing.

The image-forming face of the intermediate transfer member may not absorb liquid. A surface that cannot absorb liquid is easily kept clean by cleaning with the cleaning unit, and, in addition, can be advantageously used in an inkjet recording method such as variable data printing. The image-forming face can have such releasability as can stably transfer intermediate images to the recording medium.

The intermediate transfer member may be a blanket used for ordinary printing, which may be surface-treated, or a rubber sheet, such as that of NBR, urethane rubber, silicone rubber, fluorocarbon rubber, nitrile rubber, chloroprene rubber, or natural rubber. Such an intermediate transfer member can be disposed in a replaceable manner. These materials may be directly formed into a shape of a belt or a roller. For example, a silicone rubber intermediate transfer member may be used.

### Application of Aggregating Agent

The aggregating agent used in the present embodiment aggregates the coloring material in the ink used for forming images. In the step of applying the aggregating agent, the aggregating agent is applied onto the image-forming face of the intermediate transfer member. The aggregating agent can be appropriately selected according to the type of the ink used for forming images. For example, if a dye ink is used, a polymeric aggregating agent can be used. If a pigment ink is used, an aggregating agent containing a metal ion can be used. If a metal ion and a polymeric aggregating agent are used in combination for a dye ink, a pigment having the same hue as the dye can be added to the ink, or white or transparent particles that are unlikely to affect the color of the ink may be added.

Examples of the polymeric aggregating agent include cationic polymer aggregating agents, anionic polymer aggregating agents, nonionic polymer aggregating agents, and amphoteric polymer aggregating agents. Examples of the metal ion include divalent metal ions, such as Ca²⁺, Cu²⁺, Ni²⁺, Mg²⁺, and Zn²⁺, and trivalent metal ions, such as Fe³⁺ and Al³⁺. For applying an aggregating agent containing these metal ions, it can be applied as an aqueous solution of a metal salt. The anion of the metal salt may be Cl⁻, NO₃⁻, SO₄²⁻, I⁻, Br⁻, ClO₃⁻, or RCOO⁻ (R represents an alkyl group). Materials having opposite properties to the ink can be used as the aggregating agent. For example, when the ink is anionic or alkaline, a cationic or acid aggregating agent can be used.

The aggregating agent can be prepared so as to be easy to deposit to the lyophilic portions of the intermediate transfer member, and easy to repel from the lyophobic portion. For preparing such an aggregating agent, a surfactant can be used. The surfactant may be an anionic surfactant, a cationic surfactant, a nonionic surfactant, an amphoteric surfactant, a silicone surfactant, or a fluorinated surfactant. Although any surfactant can be appropriately used, it should be avoided that an anionic surfactant is used in a cationic aggregating agent. Many of the surfactants are dispersed in water so that their molecules are aligned along the interface with a gas to function as intended. Since even a trace amount of surfactant can produce an effect, it can adjust the characteristics of the aggregating agent without changing the composition of the aggregating agent. For example, an aqueous aggregating agent can be used because its characteristics are easy to adjust.

Since the image-forming face of the intermediate transfer member used in the present embodiment has a pattern including lyophilic portions and a lyophobic portion, the aggregating agent can be uniformly and stably applied with a very simple application device. The application device 3 for applying the aggregating agent, shown in FIG. 1, is in a form of rollers (application rollers) like a roll coater. The aggregating agent applied with the application device 3 is held only on the lyophilic portions of the intermediate transfer member. If application rollers apply the aggregating agent, the aggregating agent comes into contact with both the lyophilic portions and the lyophobic portion without distinction. However, the lyophobic portion repels the aggregating agent. When an image is formed, most of the aggregating agent is present on the lyophilic portions. Although the amount of aggregating agent applied with the application rollers depends on the surface tension of the aggregating agent on the lyophilic portions, a constant amount of aggregating agent can be received by the lyophilic portions as long as the application is performed under the same conditions. A fine pattern of the lyophilic portions, which reduces the fluidity of the aggregating agent, allows the aggregating agent to be uniformly applied to the image-forming face.

For the application of the aggregating agent, devices other than application rollers can be used. For example, a contact process may be applied, such as doctor coating, die coating, wire-bar coating, or gravure roller application. Liquid ejection or other noncontact processes may be applied by using a spray coater or an inkjet head. Spin coating or dip coating may be applied, or an air knife may be used. These application methods may be combined as needed.

### Forming of Intermediate Image

In the step of forming an intermediate image, an ink containing a coloring material is applied onto the image-forming face of the intermediate transfer member on which the aggregating agent has been applied, thereby forming an intermediate image. The ink contains, for example, a dye or a pigment as the coloring material. If the aggregating agent contains a metal salt, a pigment ink can react at an extremely high rate, and is therefore advantageous in terms of high-speed image recording.

Widely and generally used dyes may be used in the ink. Examples of such a dye include C. I. Direct Blues 6, 8, 22, 34, 70, 71, 76, 78, 86, 142 and 199; C. I. Acid Blues 9, 22, 40, 59, 93, 102, 104, 117, 120, 167 and 229; C. I. Direct Reds 1, 4, 17, 28, 83 and 227; C. I. Acid Reds 1, 4, 8, 13, 14, 15, 18, 21, 26, 35, 37, 249, 257 and 289; C. I. Direct Yellows 12, 24, 26, 86, 98, 132 and 142; C. I. Acid Yellows 1, 3, 4, 7, 11, 12, 13, 14, 19, 23, 25, 34, 44 and 71; C. I. Food Blacks 1 and 2; and C. I. Acid Blacks 2, 7, 24, 26, 31, 52, 112 and 118.

Widely and generally used pigments may also be used. Examples of such a pigment include C. I. Pigment Blues 1, 2, 3, 15:3, 16 and 22; C. I. Pigment Reds 5, 7, 12, 48(Ca), 48(Mn), 57(Ca), 112 and 122; C. I. Pigment Yellows 1, 2, 3, 13, 16 and 83; carbon black Nos. 2300, 900, 33, 40 and 52; MA7, MA8 and MCF88 (each produced by Mitsubishi Chemicals); RAVEN 1255 (produced by Columbian Chemicals); REGAL 330R, 660 μl and MOGUL (produced by Cabot); and Color Blacks FW1, FW18, 5170, 5150 and Printex 35 (produced by Degussa).

These pigments may be self-dispersible, resin-dispersible, or microencapsulated. A water-soluble resin having a weight average molecular weight in the range of 1000 to 15000 can be sued as a dispersant of the pigment. Examples of such a dispersant resin include block or random copolymers or their salts containing some of styrene and its derivatives, vinyl naphthalene and its derivatives, aliphatic alcohol esters of α,β-ethylenic unsaturated carboxylic acids, acrylic acid and its derivatives, maleic acid and its derivatives, itaconic acid and its derivatives, and fumaric acid and its derivatives, and salts of these polymers.

In order to enhance the fastness of the final image on the recording medium, a water-soluble resin or a water-soluble crosslinking agent may be added to the ink. Any of the above-cited dispersant resins can be further added as the water-soluble resin. The water-soluble crosslinking agent can be oxazoline or carbodiimide, which are less reactive, in view of the stability of the ink.

If the ink contains an organic solvent, the organic solvent content is one of the factors of the ejection property and drying property of the ink. Since the ink immediately before being transferred to the recording medium 9 contains substantially only a coloring material and a high-boiling point organic solvent, the organic solvent content is controlled to an optimal value in this state. The organic solvent can be soluble in water and have a high boiling point and a low vapor pressure. Examples of such an organic solvent include polyethylene glycol, polypropylene glycol, ethylene glycol, propylene glycol, butylene glycol, triethylene glycol, thiodiglycol, hexylene glycol, diethylene glycol, ethylene glycol monomethyl ether, diethylene glycol monomethyl ether, and glycerin. In addition, an alcohol, such as ethyl alcohol or isopropyl alcohol, may be added to adjust the viscosity, the surface tension or the like.

The proportions of the constituents in the ink can be appropriately adjusted according to the ejection power of the inkjet recording method or the inkjet recording head, and the diameter of the nozzles. For example, the ink can have the composition containing 0.1% to 10.0% by mass of coloring material, 0.1% to 10.0% by mass of water-soluble resin, 5.0% to 40.0% by mass of organic solvent, 0.1% to 5.0% by mass of surfactant, and the balance of water.

When the ink is ejected from an inkjet recording head and comes into contact with the aggregating agent on the image-forming face of the intermediate transfer member, the fluidity of the ink is reduced. Consequently, the occurrence of bleeding and beading can be reduced. Since the aggregating agent on the intermediate transfer member is controlled so as to be thin and uniform, the image disruption is unlikely to occur. In addition, because of the effect of the lyophobic portion disposed with constant spaces on the intermediate transfer member, the intermediate image on the intermediate transfer member is not displaced throughout the process up to the transfer, and thus the quality of the image can be kept high.

In the inkjet recording method, the ink may be ejected by a thermal jet method using a thermal energy, or a piezoelectric method using a mechanical energy. Also, the inkjet recording method may be performed in an on-demand manner or a continuous manner. A method using a dispenser or the like may be applied. The inkjet recording head used in, for example, the configuration shown in FIG. 1 may be in a line head form that has ink ejection orifices arranged in the direction of the axis of the intermediate transfer member 1 (in the direction perpendicular to the sheet of the figure). Alternatively, a head having ejection orifices arranged in a region along a tangent or the circumference of the intermediate transfer member 1 may scan in the axis direction for recording. In addition, a number of heads may be used corresponding to the number of ink colors used for forming images.

Any type of intermediate image can be formed without limitation, including characters, illustrations, natural images, simple patterns, and industrial patterns such as electronic circuit diagrams. For forming an image, allowing for transfer that reverses the image, the ink can be ejected so as to form a mirror-reverse image.

### Transferring

In the step of transferring, a recording medium is pressed on the image-forming face on which the intermediate image has been formed. Thus, the intermediate image on the image-forming face is transferred to the recording medium, thereby forming an image. In FIG. 1, the recording medium 9 is brought into contact with the image-forming face 2 of the intermediate transfer member 1 by the pressure roller 10, and, thus, the intermediate image is transferred. If the amount of the ink on the intermediate transfer member 1 is large, image disruption may occur due the pressure for transfer. In order to prevent such image disruption, the volume of the ink can be reduced before transfer by reducing the water content in the ink. Ordinary inks can be reduced in volume to about 1/10 to ⅕ by reducing the water content. Thus, satisfactory images can be formed even on a less-absorbent or nonabsorbent recording medium. The ink (concentrated ink) whose viscosity has been increased by removing the water can be efficiently transferred, and accordingly, the amount of ink remaining on the intermediate transfer member can be reduced. Waves of the recording medium, which are caused by water absorption when thin paper is used as the recording medium, can be prevented.

In order to reduce the volume of the ink, the rotation speed may be reduced so that more time can be taken to evaporate the water in the ink. Allowing for cases where high-speed recording is required, a water removal accelerator 7 and/or a heating roller 8 may be used to remove the water, as shown in FIG. 1. In the configuration shown in FIG. 1, the water removal accelerator 7 is a blower or the like, and the heating roller 8 is a heater that is disposed in contact with the inner wall of the hollow intermediate transfer member 1 to heat it by heat conduction. Other techniques can be appropriately applied to remove the water without limitation to the above. For example, a heat source that can emit heat rays may be used, or warm wind or the like may be blown to accelerate the evaporation of water.

In the configuration shown in FIG. 1, the final image formed on the recording medium may be brought into contact with a heat roller or the like to impart a fastness or a gloss to the image. In the configuration shown in FIG. 1, the cleaning unit 12 washes the image-forming face of the intermediate transfer member after transfer, thereby removing particles of paper, dust, or remaining ink. The washing may be performed by rinsing or wiping the image-forming face while showering, by bringing the image-forming face into contact with a water surface or other direct washing, or by bringing a wet molton roller into contact with the image-forming face for wiping. These methods may be combined. A surfactant may be used for washing. In addition, the image-forming face, after being washed, may be dried, if necessary, by contact with a dry molton roller or rubber wiper, or by blowing. For satisfactory cleaning at this time, the image-forming face can be smooth without asperities.

### Examples

The transfer inkjet recording method will be further described in detail with reference to Examples. In the following examples, the apparatus shown in FIG. 1 was used as a transfer inkjet recording apparatus. The contact angle mentioned in the examples was a value measured with a contact angle meter DM-701 (manufactured by Kyowa Interface Science), and the amount of aggregating agent applied was obtained by weighing with an electronic balance.

### Example 1

### (a) Patterning of Image-Forming Face of Intermediate Transfer Member

A pattern including lyophilic portions and a lyophobic portion was formed on the image-forming face of an intermediate transfer member. First, the surface of a 0.4 mm thick PET film was coated with a silicone rubber having a hardness of 40° (KE-1310, produced by Shin-Etsu Chemical) at a thickness of 0.2 mm. The resulting film was used as the intermediate transfer member. A resist layer was formed over the entire surface (image-forming face) of the intermediate transfer member to a thickness of 0.5 μm by applying a positive resist (OFPR-700, produced by Tokyo Ohka Kogyo) using a spin coater, and then drying the resist. The dried resist layer was exposed to light through a photomask having the pattern shown in FIG. 5A (regions for lyophilic portions are open). The pattern to be formed was as follows:
Small lyophilic portions: diameter of 12 μm, pitch of 1200 dpi
Large lyophilic portions: diameter of 25 μm, pitch of 600 dpi
Ratio of the number of small lyophilic portions to the number of large lyophilic portions=4:1

Then, the surface of the intermediate transfer member on which the resist pattern had been formed was subjected to surface modification with a parallel plate plasma apparatus under the following conditions:
Gases and their flow rates: air, 1000 cc/min; N₂, 6000 cc/min
Input voltage: 230 V
Frequency: 10 kHz
Treatment speed: 100 mm/min

A plasma gas reached the silicone rubber surface through the openings in the resist layer and thus turns lyophilic the portions of the silicone rubber corresponding to the openings. On the other hand, the portion of the silicone rubber masked with the resist layer was not turned lyophilic and resulted in a lyophobic portion. Thus, the pattern including lyophilic portions and a lyophobic portion was formed on the image-forming face of the intermediate transfer member.

Subsequently, the entire surface of the resist pattern was exposed to light. After a predetermined development was performed, the resist layer was removed from the intermediate transfer member. Thus, a pattern having no steps between the lyophilic portions and the lyophobic portion was formed on the image-forming face of the intermediate transfer member.

The resulting intermediate transfer member was wound around an aluminum drum and secured to the transfer inkjet recording apparatus shown in FIG. 1. Then, an aggregating agent having the following composition was applied to the intermediate transfer member with a roll coater.

### Composition of Aggregating Agent:

Ca (NO₃)₂.4H₂O: 50 parts by mass
Surfactant (Acetylenol EH, produced by Kawaken Fine Chemical): 1 part by mass
Diethylene glycol: 9 parts by mass
Pure water: 40 parts by mass

The aggregating agent was selectively deposited on the lyophilic portions. The contact angle of the aggregating agent with the lyophilic portions was 38°, and the contact angle of the aggregating agent with the lyophobic portion was 68°. The amount of aggregating agent applied to the intermediate transfer member was 0.37 mg per square inch.

### (b) Forming of Intermediate Image

Using an inkjet apparatus (nozzle density: 1200 dpi; ejection amount: 4.8 μL; driving frequency: 12 kHz), a mirror-reverse intermediate image was formed (resolution: 1200 dpi) by applying an ink onto the intermediate transfer member on which the aggregating agent had been applied. The compositions of inks were as follows (four color inks containing respective pigments were prepared).

### Ink Compositions:

Any one of the following pigments: 3 parts by mass
   Black: carbon black (MCF88, produced by Mitsubishi Chemical)
   Cyan: Pigment Blue 15
   Magenta: Pigment Red 7
   Yellow: Pigment Yellow 74
Styrene-acrylic acid-ethyl acrylate copolymer (acid value: 240; weight average molecular weight: 5000): 1 part by mass
Glycerin: 10 parts by mass
Ethylene glycol: 5 parts by mass
Surfactant (Acetylenol EH, produced by Kawaken Fine Chemical): 1 part by mass
Pure water: 80 parts by mass

At the time when the intermediate image was formed on the intermediate transfer member, whether or not image disruption (bleeding) occurred was determined by visual observation. Image disruption was not observed even in dense color regions (where 20 mg per square inch of ink had been applied). The reproduction resolution was constant, and image disruption was not observed even in single-color fine line drawings or characters.

### (c) Transferring

After the water in the intermediate image was removed to reduce the fluidity, a recording medium (Aurora Coat, manufacture by Nippon Paper Industries, basis weight: 63 g) was brought into contact with the intermediate image by a pressure roller to transfer the image to the recording medium. It was visually confirmed that a high-quality final image was recorded on the recording medium. After the transfer, the ink was hardly left on the intermediate transfer member, and subsequent recording was able to be performed satisfactorily without treatment of the intermediate transfer member.

### Example 2

### (a) Patterning of Image-Forming Face of Intermediate Transfer Member

The following pattern including lyophilic portions and a lyophobic portion was formed on the image-forming face of an intermediate transfer member through a photomask having the pattern shown in FIG. 6A by the same procedure as in Example 1.
Small lyophilic portions: diameter of 10 μm, pitch of 1200 dpi
Large lyophilic portions: diameter of 20 μm, pitch of 1200 dpi
Ratio of the number of small lyophilic portions to the number of large lyophilic portions=83:17

Then, the same aggregating agent was applied onto the surface of the intermediate transfer member by the same procedure as in Example 1. The aggregating agent was selectively deposited on the lyophilic portions, as in Example 1. The contact angle of the aggregating agent with the lyophilic portions was 35°, and the contact angle of the aggregating agent with the lyophobic portion was 70°. The contact angles were substantially the same as in Example 1. The amount of aggregating agent applied to the intermediate transfer member was 0.34 mg per square inch.

### (b) Forming of Intermediate Image

An intermediate image was formed on the intermediate transfer member to which the aggregating agent had been applied, by the same procedure as in Example 1.

At the time when the intermediate image was formed on the intermediate transfer member, whether or not image disruption (bleeding) occurred was determined by visual observation. Image disruption was not observed even in dense color regions (where 20 mg per square inch of ink had been applied). The reproduction resolution was constant, and image disruption was not observed even in single-color fine line drawings or characters.

### (c) Transferring

After the water in the intermediate image was removed to reduce the fluidity, a recording medium (Aurora Coat, manufacture by Nippon Paper Industries, basis weight: 63 g) was brought into contact with the intermediate image by a pressure roller to transfer the image to the recording medium. It was visually confirmed that a high-quality final image was recorded on the recording medium. After the transfer, the ink was hardly left on the intermediate transfer member, and subsequent recording was able to be performed satisfactorily without treatment of the intermediate transfer member.

### Comparative Example 1

### (a) Patterning of Image-Forming Face of Intermediate Transfer Member

The following pattern including lyophilic portions and a lyophobic portion was formed on the image-forming face of an intermediate transfer member through a photomask having the pattern shown in FIG. 2A by the same procedure as in Example 1.
Lyophilic portions: diameter of 12 μm, pitch of 1200 dpi

Then, the same aggregating agent was applied onto the surface of the intermediate transfer member by the same procedure as in Example 1. The aggregating agent was selectively deposited on the lyophilic portions, as in Example 1. The contact angle of the aggregating agent with the lyophilic portions was 38°, and the contact angle of the aggregating agent with the lyophobic portion was 68°. The contact angles were substantially the same as in Example 1. The amount of aggregating agent applied to the intermediate transfer member was 0.16 mg per square inch.

### (b) Forming of Intermediate Image

An intermediate image was formed to the intermediate transfer member to which the aggregating agent had been applied, by the same procedure as in Example 1.

At the time when the intermediate image was formed on the intermediate transfer member, whether or not image disruption (bleeding) occurred was determined by visual observation. As a result, color mixing was observed in dense color regions (where 20 mg per square inch of ink had been applied), clearly showing that aggregation of the inks had been insufficient.

### Comparative Example 2

### (a) Patterning of Image-Forming Face of Intermediate Transfer Member

The following pattern including lyophilic portions and a lyophobic portion was formed on the image-forming face of an intermediate transfer member through a photomask having the pattern shown in FIG. 3A by the same procedure as in Example 1.
Lyophilic portions: diameter of 25 μm, pitch of 600 dpi

Then, the aggregating agent having the following composition was applied onto the surface of the intermediate transfer member by the same procedure as in Example 1.

### Composition of Aggregating Agent:

CaCl₂.2H₂O: 50 parts by mass
Surfactant (Acetylenol EH, produced by Kawaken Fine Chemical): 1 part by mass
Diethylene glycol: 9 parts by mass
Pure water: 40 parts by mass

The aggregating agent was selectively deposited on the lyophilic portions, as in Example 1. The contact angle of the aggregating agent with the lyophilic portions was 38°, and the contact angle of the aggregating agent with the lyophobic portion was 68°. The contact angles were substantially the same as in Example 1. The amount of aggregating agent applied to the intermediate transfer member was 0.38 mg per square inch.

### (b) Forming of Intermediate Image

An intermediate image was formed on the intermediate transfer member to which the aggregating agent had been applied, by the same procedure as in Example 1.

At the time when the intermediate image was formed on the intermediate transfer member, whether or not image disruption (bleeding) occurred was determined by visual observation. Image disruption was not observed even in dense color regions (where 20 mg per square inch of ink had been applied). However, the reproduction resolution was varied. The single-color fine drawings were disrupted, and many of the characters were distorted and thickened.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-242466 filed Oct. 28, 2010, which is hereby incorporated by reference herein in its entirety.

What is claimed is:

1. A transfer inkjet recording method comprising the steps of:
applying an aggregating agent capable of aggregating a coloring material contained in an ink onto an image-forming face of an intermediate transfer member, the image-forming face having a pattern including lyophilic portions and a lyophobic portion, the lyophilic portions including at least two types of portions having different areas;
forming an intermediate image by applying the ink onto the image-forming face on which the aggregating agent has been applied; and
transferring the intermediate image to a recording medium by pressing the recording medium on the image-forming face on which the intermediate image has been formed.

2. An intermediate transfer member used in a transfer inkjet recording method, the intermediate transfer member comprising:
an image-forming face having a pattern including lyophilic portions and a lyophobic portion, the lyophilic portions including at least two types of portions having different areas.

3. A transfer inkjet recording apparatus comprising:
the intermediate transfer member as set forth in claim 2;
an application section that applies an aggregating agent; and
an inkjet recording head that applies an ink.
